(19) United States
(12) Patent Application Publication
(10) Pub. No.: US 2012/0118150 A1
(43) Pub. Date: May 17, 2012

(54) Air treatment system and method

(76) Inventors: Christopher Brizes, Westlake, OH (US); James P. Cooney, Concord, OH (US); Tianwen Zhang, Hong Kong (HK)

(21) Appl. No.: 11/798,916

(22) Filed: May 17, 2007

Related U.S. Application Data
(60) Provisional application No. 60/800,850, filed on May 17, 2006.

(51) Int. Cl. B03C 3/017

(52) U.S. Cl. 95/69; 96/16

(57) ABSTRACT

A device for reducing airborne contaminants is provided. The device includes an intake enclosure having an intake manifold at an open end thereof, a UV light emitter disposed within the intake enclosure, an exhaust enclosure having an exhaust manifold at an open end thereof, an electrostatic filter disposed within the exhaust enclosure, a second filter disposed within the exhaust enclosure, the second filter including at least one of activated carbon and HEPA filter material, a base forming a base conduit connecting the intake enclosure and the exhaust enclosure and providing fluidic communication therebetween, and a fan disposed in the base conduit, the fan being adapted to generate an airflow passing the UV light emitter in the intake enclosure and through the electrostatic and second filters in the exhaust enclosure. A method for reducing airborne contaminants is also disclosed.

The disclosure claims the filing-date benefit of Provisional Application No. 60/800,850, filed 17 May 2006, the specification of which is incorporated herein in its entirety.

### BACKGROUND

The role of air quality in personal health is increasingly being recognized as the public is exposed to dramatic news of widespread sickness and death brought on by airborne contaminants and pathogens including viruses and bacteria. These health threats include aerosolized anthrax, tuberculosis, SARS, avian flu, and influenza.

For example, in recent years, the media has whipped the public into a frenzy regarding the threat of a “bird flu” pandemic similar to the influenza pandemic of 1918. This new influenza pandemic has the potential to kill millions of Americans and hundreds of millions worldwide. The public has reacted by forcing the makers of vaccines such as TamiFlu and Relenza to ration their products. These vaccines are possibly effective against the bird flu strain of H5NI now seen in Asia. Based on this promise, the public has at least some hope that vaccines like TamiFlu can save lives. However, the H5NI virus could easily develop resistance to TamiFlu or any other developed vaccine as it mutates to its human-infecting form. Thus, even as world governments push for a H5NI vaccine, it is still unclear that the vaccine will address the human-to-human strain if or when this mutation occurs.

The CDC and other authorities typically promote hand washing and covering the mouth to restrict the droplet/nuclei transmission of the influenza virus. However, aerosolized transmission may be the “vector of choice” for influenza. Tuberculosis (TB), a leading killer in third world countries, Russia and China, is universally transmitted in tiny aerosolized droplets. As such, the aerosolized transmission of influenza and other contagions presents several challenges.

With aerosolized transmission, the contaminants linger in the air like a fine mist long after an infected person has departed the area. When influenza is spread by aerosolized transmission, it is extremely difficult to prevent transmission to additional persons exposed to infected air. “Stopping the Killer Virus,” Forbes, Apr. 28, 2003, p. 48. Epidemiologic evidence supporting significance of airborne transmission of influenza includes the usual rapid increase to a peak of occurrence in most population groups and high attack rates when most persons are susceptible. Research also includes data from factories and airline flights, providing further evidence of airborne transmission.

Further, most influenza infections are likely acquired by inhalation of small (for example, 1-5 μm diameter) infectious particles. Moreover, the amount of influenza virus needed to cause infection is 100 times greater through direct contact (a mode of transmission which might be mitigated by washing hands) than through aerosolized transmission. For example, studies have shown that the amount of the virus required to infect the lower respiratory tract is very small (for example, less than 5 infectious units), while almost 100 times more virus is required to infect the nasopharnyx. Paul Glazen & Robert B. Counch, “Influenza Viruses,” Influenza Research Center, Department of Microbiology and Immunology, Baylor College of Medicine, Houston, Tex. Another article noted the acute problems from infection caused by aerosolized influenza. In the study disclosed in this article, administration of intranasal droplets was associated with milder disease and required larger inoculums than the inhalation of smaller (for example, less than 10 μm diameter) particles. Thus, the amount of virus required to induce infection is inversely related to the size of the infectious particles administered, with particles less than 10 μm in diameter more likely to cause infection in the lower respiratory tract. Carolyn Buxton Bridges, Matthew J. Kuehnert, “Transmission of Influenza: Implications for Control in Healthcare Settings. Healthcare Epidemiology,” 1094 CID 2003:37 (15 October), pp. 1094-1101, Division of Viral and Rickettsial Diseases, National Center for Infectious Diseases, Center for Disease Control and Prevention, Atlanta, Ga.

The usefulness of UV-C products in affecting the transmission of various communicable health threats has been recognized. For example, UV-C has been found useful in treating the effluent (i.e., sewage/waste) water from a trailer park and reducing airborne e-coli/salmonella in food processing plants. Applications of UV-C for disease prevention have generally been limited until recently. However, UV-C has reemerged as a method to destroy germs through irradiation. For example, a medical and scientific group at Harvard and St. Vincent's Hospital—Manhattan published an update in Public Health Reports related to the application of UV light to fight bioterrorism, “The Application of Ultraviolet Germicidal Irradiation to Control Transmission of Airborne Disease: Bio-Terrorism Countermeasure” (April 2003). Further, the group TUSS (Tuberculosis and UV Shelter Study) conducted field trials on the effects of UV in homeless shelters for ten years. Aerosolized droplets carrying TB are susceptible to UV-C irradiation. In yet another study, a JAMA article described that patients housed in a building with UV lights experienced a lower illness rate than patients housed in a building without UV lights during an outbreak of influenza. During the outbreak, the illness rate was 19% among those in rooms without UV lights and only 2% among those in rooms with ultraviolet lights. Riley, et al. “Airborne Infection,” Am. J. Med., 57:466-75 (1974).

Thus, UV-C is an important weapon against influenza and even the bird flu. For example, UV-C can destroy a significant portion of the influenza or bird flu virus in the air. Further, it is important to kill influenza germs in the air because aerosolized germs are 100 times more potent than wet germs (for example, those transmitted in saliva, phlegm, etc.). Additionally, aerosolized germs such as bird flu have resulted in rapid and widespread death (for example, aerosolized droplets of SARS in Hong Kong killed 44 in an apartment complex, and 9 nurses were killed in Toronto by one coughing SARS patient). UV-C can reduce the probability of infection by 90%.

The media has created, and will continue to create, a demand for products, technologies and methods to combat the avian flu and other diseases such as pandemic influenza. Consumers increasingly realize that they cannot rely only on the government during a crisis—they must take individual actions to be prepared. Consumers also recognize the usefulness of air treatment units within their homes to combat the more common and seasonally consistent outbreaks of influenza. Some conventional systems have emerged in the marketplace which employ UV treatment of air. However, these conventional systems suffer from a variety of shortcomings.

For example, there are some useful medical units on the market, most made by Atlantic Ultraviolet. However, the medical units are extremely expensive and allow too much UV-C to escape to be safe for residential use. Sharper Image sells an air cleaner that treats very little air and is also very expensive. Other UV-C products such as HVAC ductwork devices blow too much air (hundreds of cubic feet per minute) to come near a 99% effective dose. of UV-C energy since germs are not exposed for a sufficient amount of time to reduce the majority of concentration in the air. Ductwork devices also only provide intermittent airflow which is controlled, for example, by a thermostat. Further, ductwork units are also remotely located, so they do not impact air which might be highly concentrated with germs emanating from an infected person in the room. Also, ductwork is often non-reflective and quickly accumulates dust and dirt, so the effectiveness of the UV-C energy is vastly reduced.

Many conventional systems also generate excessive amounts of ozone to be safe for residential environments. For example, conventional residential ionizers attempt to clean the air using electrostatic precipitation, a process which produces ozone, thereby doing more harm than good. The EPA and FDA both caution against ozone exposure, especially for those with allergies or cardiopulmonary problems. Ironically, it is these high-risk individuals who often purchase air cleaning equipment. By introducing an ozone-generating air cleaning system into an enclosed room, the individual is exposed to serious risk not only from the ozone itself but from its interaction with other chemicals inside a typical residence. For example, ozone reacts with scented air fresheners to produce formaldehyde, a known carcinogen. In short, conventional systems are not optimized for safety, effectiveness, and cost.

UV-C air treatment implemented in air cleaners used in a residential setting has the potential to provide consumers with an effective and useful way to respond to the influenza virus and other airborne health threats. However, there remains a need in the industry to provide systems and methods to treat the air while addressing and appropriately balancing issues of safety, effectiveness, and cost.

### SUMMARY

The present application relates generally to the treatment of air. In particular, the present application relates to the treatment of air using a variety of treatments. These treatments include UV light, electrostatic filtering, activated carbon or charcoal, and HEPA filtering.

A device for reducing airborne contaminants is provided, the device including an intake enclosure having an intake manifold at an open end thereof, a UV light emitter disposed within the intake enclosure, an exhaust enclosure having an exhaust manifold at an open end thereof, an electrostatic filter disposed within the exhaust enclosure, a second filter disposed within the exhaust enclosure, the second filter including at least one of activated carbon and HEPA filter material, a base forming a base conduit connecting the intake enclosure and the exhaust enclosure and providing fluidic communication therebetween, and a fan disposed in the base conduit, the fan being adapted to generate an airflow passing the UV light emitter in the intake enclosure and through the electrostatic and second filters in the exhaust enclosure. A method for reducing airborne contaminants is also disclosed.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the claims.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, wherein:

FIG. 1 is a schematic representation of an exemplary embodiment of a portable device;

FIG. 2 is a schematic representation of an exemplary embodiment of an alternative configuration of the portable device;

FIG. 3 is a schematic representation of an exemplary embodiment of a supplemental filter assembly;

FIG. 4 illustrates an exemplary method of reducing airborne contaminants;

FIG. 5 illustrates a first portion of another alternative exemplary embodiment of a portable device;

FIG. 6 illustrates a second portion of another alternative exemplary embodiment of a portable device; and

FIG. 7 illustrates an exemplary embodiment of an integrated supplemental filter assembly.

### DETAILED DESCRIPTION

A disclosed aspect provides an air treatment system employing UV treatment, electrostatic filtering, and activated carbon or HEPA filtering. In another aspect, a UV-C light emitter is disposed within an intake enclosure, an electrostatic filter and a carbon filter are disposed within an exhaust enclosure, the intake and exhaust enclosures are connected by a conduit, and a fan is disposed in the conduit. A further aspect includes an integrated two-stage filter. Another aspect includes an intake enclosure with an interior surface that is highly reflective to UV-C energy. In yet another aspect, a control unit is provided. In a further aspect, a scent emitter is provided. In yet an additional aspect, a safety switch is provided.

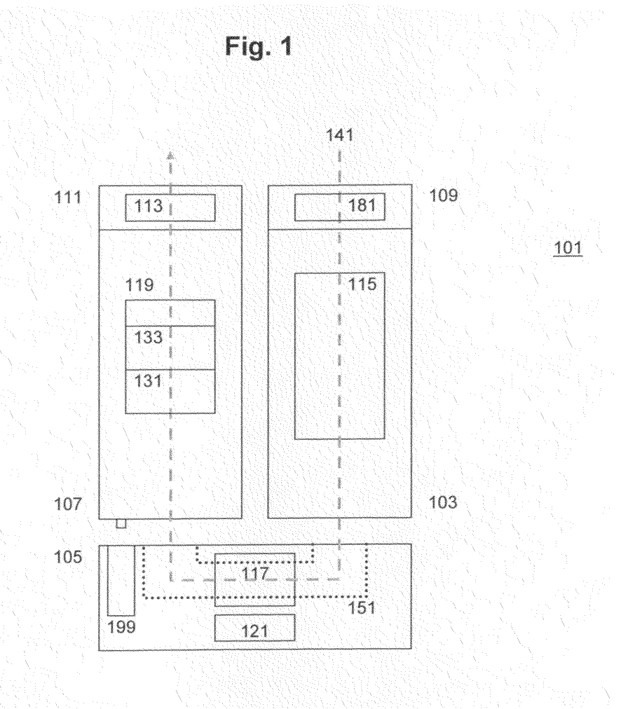

FIG. 1 is a schematic representation of an exemplary embodiment of a portable device 101 for reducing airborne contaminants. The exemplary embodiment includes a base 105, an intake enclosure 103 having an intake manifold 109 at an open end, and an exhaust enclosure 107 having an exhaust manifold 111 at an open end. The base 105 forms a base conduit 151 connecting the intake enclosure 103 and the exhaust enclosure 107. The base conduit 151 provides fluidic communication between the intake enclosure 103 and the exhaust enclosure 107. A fan 117 is disposed in the base 105, for example, in the base conduit 151. A UV light emitter 115 is disposed within the intake enclosure 103. Supplemental filters 119 such as an electrostatic filter 131 and a second filter 133 are disposed within the exhaust enclosure 107. The second filter 133 includes filter material such as activated carbon and/or HEPA filter material. In various embodiments, the fan 117 is adapted to generate an airflow 141 passing the UV light emitter 115 in the intake enclosure 103 and through the electrostatic 131 and second 133 filters in the exhaust enclosure 107. Various other components such as a power supply and power/control wiring are also provided, for example, in the base 105. The device 101 optionally includes a safety device 199 disposed, for example, in the base 105. The device 101 also optionally includes a scent emitter 113 disposed, for example, in the exhaust manifold 111. Optionally, a control unit 121 is included to enhance the operating capabilities of the device 101.

Disclosed embodiments treat air with UV-C energy to neutralize airborne viruses, bacteria, and other contaminants. The device 101 targets these sources of infection with an intense dose of UV-C energy. During operation, the UV-C emitter bulb creates UV-C light to sanitize the air based on the intensity of the UV-C energy and the residence time of the air that passes in sight of the bulb.

Certain embodiments use a quartz glass UV-C emitter with an electronic ballast. In these embodiments, quartz is used (for example, instead of soft glass) to maintain initial UV-C output. Quartz glass maintains the life of the bulb, and enables the emitter to produce light energy at approximately 254 nm (around the UV-C band) while limiting the production of light energy at approximately 185nm (an ozone-producing range of UV spectrum) light. Accordingly, the UV-C energy from the UV-C emitter 115 produces little to no harmful ozone.

Optionally, the device 101 is user-serviceable, allowing the user to access the interior of the device 101 to, for example, replace the UV-C emitter 115 or filters 131, 133. Access to the UV-C emitter is optionally provided by removing the intake enclosure or a combination of the intake and exhaust enclosures 103, 107. Although the UV-C emitter 115 may employ any suitable type of power or control interface, certain embodiments employ a unique screw-in socket combination for enhanced reliability and safety. For example, an electronic ballast/bulb combination with a familiar threaded socket is optionally utilized to allow the devices to be serviceable by service staff or by the user. Further, as the ballast tends to have a life similar to the bulb, a combination enables both to be conveniently replaced at the same time. Similar to the general case of fluorescent bulbs, when the UV-C bulb burns out (which is generally the only failure mode for a bulb), the ballast is also likely to expire and require replacement. Alternative embodiments provide for a replacement signal to be generated by the bulb or ballast for transmission to, for example, a control unit 121 to notify a user that a replacement will soon be necessary.

In certain embodiments, a non-standard or not-readily-available socket (such as an E14 socket) is used to prevent a user from accidentally using a standard light bulb. In these embodiments, a standard bulb (for instance, a standard bulb in the US market) will not fit into the socket provided in the device.

In various embodiments, the sterilizing effect within the intake chamber 103 is further enhanced by providing a highly reflective interior surface in the intake chamber 103. In certain embodiments, highly reflective metal such as aluminum is used to achieve over 80% reflectance of UV-C energy. Using a highly reflective material such as metal, metallic material, or specially designed durable plastic/polymer increases the intensity of UV-C radiation in the intake chamber, thereby providing a “killing chamber” effect which decreases the time required to kill, destroy, or deactivate the viruses, bacteria or spores that enter the intake chamber.

Optionally, the intake chamber 103 or intake manifold 109 includes an electrostatic pre-filter 181. The electrostatic pre-filter captures dirt, dust, and other particulate matter before air is exposed to the UV-C emitter. This filter is optionally removable, reusable, or disposable. Providing this filter increases the lifetime and effectiveness of the UV-C emitter by preventing accumulation of dirt or dust or other matter on the emitter or reflective inner surface of the intake chamber.

In addition to the UV-C treatment, electrostatic and activated carbon filtering is applied to the air to further remove impurities and odors. Although UV-C energy itself neutralizes odors, this filtering is performed on effluent of the air sanitization process (after exposure to the UV-C energy). In certain embodiments, a passive, 2-stage supplemental filter 119 (including an electrostatic filter 131 and a second filter 133) captures airborne particles and consume odors. In certain embodiments, the second filter 133 includes activated carbon or charcoal. In an alternative embodiment, the second filter 133 includes HEPA filter material. In another alternative embodiment, both activated carbon and HEPA filter material are used. Optionally, this 2-stage supplemental filter 119 involves a unique shape and integration for ease of assembly, disassembly, cleaning, and replacement.

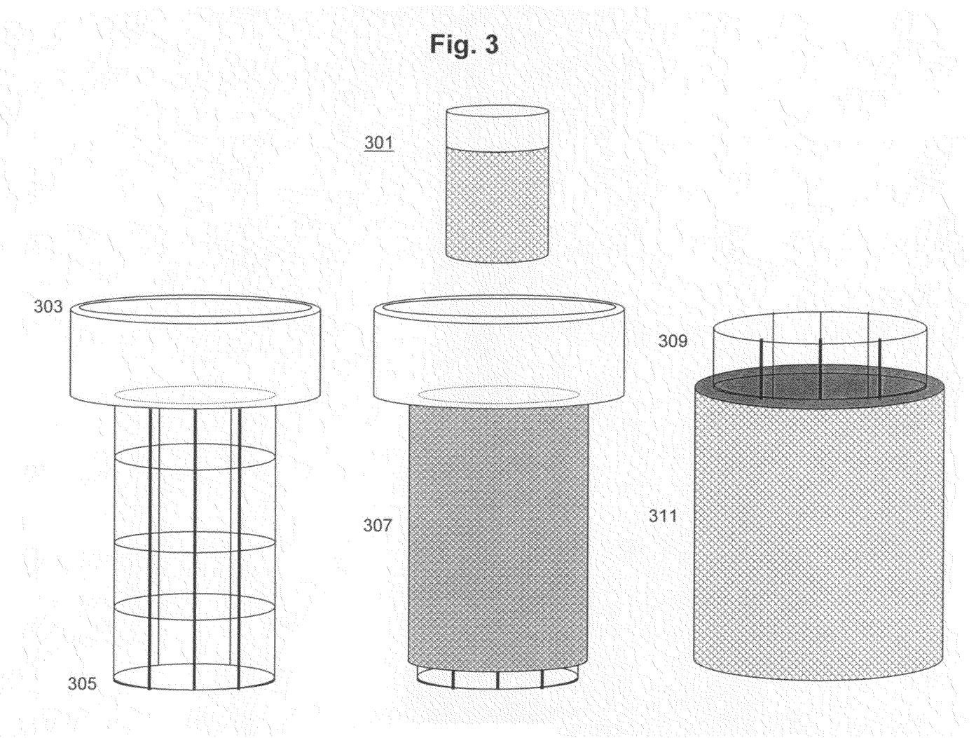

FIG. 3 is a schematic representation of an exemplary embodiment of a supplemental filter assembly 301. The supplemental filter assembly includes an electrostatic filter and a second filter. In this exemplary embodiment, the electrostatic filter includes a first rigid support member 305. In certain embodiments, the first rigid support member 305 includes an apertured cylindrical wall. The first rigid support member 305 includes a core portion 303. The core portion 303 of the electrostatic filter optionally includes tabs or other structures to secure the electrostatic module within in the device 101, for instance, within the exhaust chamber 107. Electrostatic filter material 307 is placed over the first rigid support member 305. The electrostatic filter material 307 is used to electrostatically trap small particles and dust before sterilized air is returned to the exterior of the unit. The electrostatic filter is optionally reusable (for example, capable of being rinsed, dried, and reinstalled) or disposable. The electrostatic filter material is optionally a porous foam material.

The second filter includes a second rigid support member 309. In certain embodiments, the second rigid support member 309 overlays the electrostatic filter material 307. In certain embodiments, the second rigid support member 309 includes an apertured cylindrical wall. Carbon and/or HEPA filter material 311 is placed around the second rigid support member 309. The second (carbon or HEPA) filter material 311 removes odors and finer particulate matter from the air. The carbon filters are generally replaceable after a certain component lifetime, and the HEPA filters are generally reusable (for example, capable of being rinsed, dried, and reinstalled). In certain embodiments, the first and second rigid support members 305, 309 interlock to provide an integrated supplemental filter assembly 301.

Corresponding receiving structures are optionally provided in, for example, the exhaust chamber 107 of the device 101 to receive and physically secure the supplementary filter assembly 119 as a unit or the electrostatic filter 131 and second filter 133 independently. For instance, in embodiments where the core portion 303 of the electrostatic filter include flexible tabs, complementarily-shaped recesses are optionally provided within the device 101 to receive these tabs and secure the electrostatic filter. In certain embodiments, the second filter is secured within the device 101 by the second rigid support member 309 being attached to the first rigid support member 305 of the electrostatic filter. The second filter or second rigid support member 309 is optionally supported within the device 101 by its own tabs or securing mechanism. Other suitable engaging components including, but not limited to, latches, hooks, springs, fasteners, adhesives, and magnets are optionally provided.

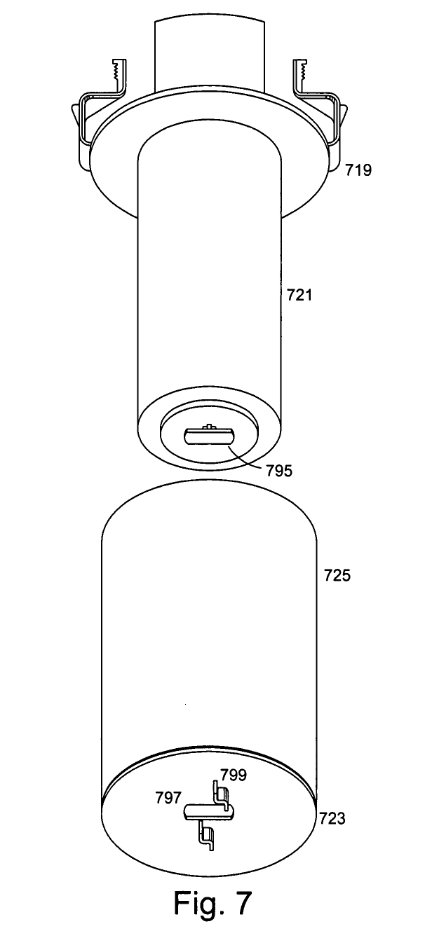

FIG. 7 illustrates an exemplary embodiment of an integrated supplemental filter assembly. In this embodiment, the second rigid support member 723 of the second filter fits over the electrostatic filter module. A rectangular extrusion or post 795 on the bottom of the electrostatic module lines up with the slot 797 in the bottom of the second rigid support member 723 of the second filter. Suitable engaging components other than the slot include, but are not limited to, latches, hooks, springs, fasteners, adhesives, and magnets. To remove the second filter overlay, the electrostatic module is rotated counterclockwise until the extrusion 795 is lined up within the slot 797, then the overlay is slid from the electrostatic module. Reinstallation is accomplished with a counterclockwise twist until the units engage. Tabs 799 are optionally provided to assist in rotation. Flexible tabs 719 are optionally provided to secure the supplemental filter assembly within the device.

Optionally, any one or more of the filtration devices such as the pre-filter, electrostatic filter, and second filter (carbon and/or HEPA) can be disabled or removed from the device. These optional embodiments enable the device to rely primarily on the UV-C energy for air treatment.

As described elsewhere, certain embodiments also provide for a scented filter 113 to safely impart a pleasing odor to the treated air. In selected embodiments of the system, a scented filter 113 is provided in the exhaust manifold 111. The scented filter 113 is shaped to avoid significantly impeding the free flow of air from the exhaust chamber 107 by, for example, providing slots or holes or channels therein. The scented filter 113 utilizes a novel process of imbedding the scent in molded polymer. In certain embodiments, scented cellulose acetate (for example, from Rotuba, Eastman Chemical) is used to impart a pleasing odor on the effluent of the air sanitization process. The scented inserts 113 are optionally available as replacements in a variety of scents including, but not limited to lemon/lime/citrus, magnolia, and gardenia.

A control unit 121 enables automatic or autonomous operation of the device 101. A remote control is also optionally provided to allow commands and displays to be input or received without resort to using a control unit 121 attached to the device. Electronics provided in the control unit 121 optionally provide enhanced capabilities such as the ability to operate the fan at various speeds, bulb and/or filter replacement notification, and automatic on/off control. In certain embodiments, the control unit 121 includes a fan speed controller (for example, to operate at 4 speeds: off, low, medium, turbo), a replacement indicator (for example, to notify consumer when to replace bulb, filter, or other component, along with appropriate resets after replacement or maintenance), a programmer (for example, so a user can program the unit to turn off or on, at any fan speed, at any time of the day), and a clock.

The timer can be set to automatically start the device at a predetermined time. Further, the time can be set to automatically stop the device at a predetermined time to provide for a desired interval of operation. Moreover, the fan speed during any part of this interval can be set to a desired level. For example, the device can be set to turn on at medium fan speed at 8:00 am, turn off at 4:30 pm, turn on at turbo fan speed at 4:35 pm, decrease to low fan speed at 10 pm, turn off at 11:00 pm, turn on at 11:45 pm at low fan speed, and turn off at 6:30 am. Any interval or group of intervals can be set to repeat, for instance, every 24 hours. Further, weekly, monthly, and yearly schedules of operation are optionally enabled.

In certain embodiments, the replacement indicator is operably connected to the clock or a timer, which records the time of operation of any component of the device including, but not limited to, the UV-C emitter 115, the fan 117, the scent emitter 113, the electrostatic filter 131, the pre-filter 181, the second filter 133, the carbon filter, and the HEPA filter. Upon receipt of a time signal or predetermined expiration signal from the timer, the replacement indicator prompts the user to replace a particular device corresponding to the signal sent from the timer. The prompt is optionally visual, aural, or operational (for example, the device might prevent itself from operating upon detection of an expiration signal related to the fan or UV-C emitter).

Although UV-C is not deadly or harmful, UV-C exposure can cause irritation of the skin and eyes. Accordingly, various embodiments provide that UV-C is contained to at or below the residential irradiance threshold as recommended by OSHA (0.2 microwatts/cm²) when measured with appropriate photometer at 2″ from any surface. Exposure to UV-C light is to be minimized during manufacture and especially during use. Further, the emitter or ballast is optionally configured to also emit an amount of visible light (for example, in the blue portion of the spectrum) to enable a user to more easily detect situations in which UV energy might be escaping the intake chamber.

In various embodiments, a safety switch 199 is provided to prevent accidental exposure of a user or repair person to UV-C or fan. In certain embodiments, the safety switch detects an exposure condition of the UV light emitter and disables the UV light emitter, the fan, or both. A visual, aural, or operational (for example, the device might prevent itself or one of its components, such as the fan or UV-C emitter, from operating upon detection of an exposure condition) warning is optionally provided. For example, the switch may detect a separation of the base from the intake enclosure. Although the safety switch 199 is illustrated in the base 105, the switch 199 can be located in a variety of locations within the device 101 corresponding to the type of exposure condition to be detected. Further, in certain embodiments, the switch is an electromechanical switch such as a push-button switch. Suitable alternative switches including, but are not limited to, pressure switches, rocker switches, safety interlock switches, toggle switches, current sensors, photo-resistors, etc.

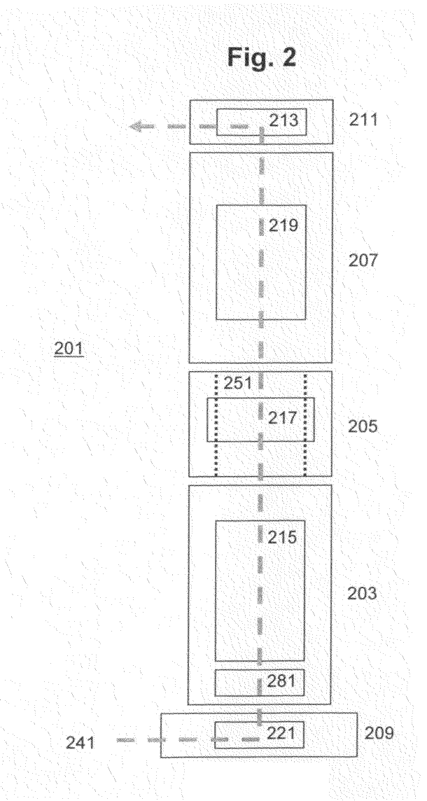

FIG. 2 illustrates an alternative embodiment of a portable device 201 for reducing airborne contaminants. In this embodiment, the intake chamber 203 is disposed below the base 205, which in turn is disposed below the exhaust chamber 207. An intake manifold 209 is provided at the bottom of the device 201 and optionally includes a control unit 221. Within the intake chamber 203, a prefilter 281 and a UV emitter 215 are disposed. Within the exhaust chamber, a supplementary filter assembly 219 is disposed. Within an exhaust manifold 211, a scent emitter 213 is optionally disposed. In the illustrated embodiment, the fan 217 is disposed in the base 205 and provides an airflow 241 through the base conduit 251. Alternatively, the device 201 can include the intake chamber 203 above the exhaust chamber 207. Various other physical configurations are also suitable, where the physical configurations are constrained by cost, convenience for the user in operating or placing of the device, and air treatment efficacy.

Optionally, any one or more of the filtration devices such as the pre-filter, electrostatic filter, and second filter (carbon and/or HEPA) are optionally disabled or removed from the device. These optional embodiments enable the device to rely primarily on the UV-C energy for air treatment.

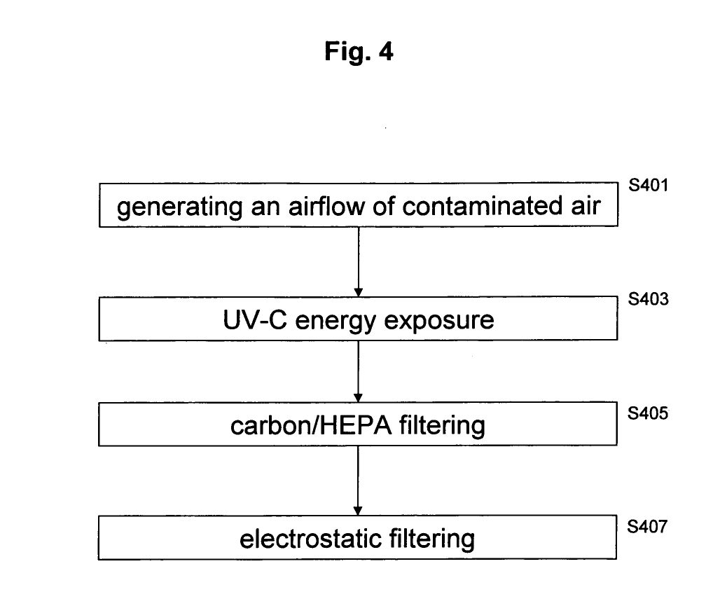

FIG. 4 illustrates an exemplary method of reducing airborne contaminants in a space. The disclosed method includes generating an airflow of contaminated air S401, exposing the airflow to UV-C energy S403, filtering the airflow with one of a carbon filter or a HEPA filter S405, and filtering the airflow with an electrostatic filter S407. Various embodiments also include exhausting the air from the filtration chamber into the space. Further, generating an airflow optionally includes drawing air from the space into a sterilization chamber (for example, an intake chamber) and causing the air to flow through the sterilization chamber. Further, embodiments of the process include moving the air flowing from the sterilization chamber into a filtration chamber (for example, an exhaust chamber) and causing the air to flow through the filtration chamber where filtering is performed. The amount of airflow generated is optimized to achieve a resident time within the sterilization chamber required to kill or disable up to 99% of the germs contained within the airflow.

In certain embodiments, pre-filtering airflow before it enters the sterilization chamber advantageously eliminates large debris to keep the internal chamber, conduit, and components (such as the fan and emitter) clean. Further, providing UV-C sterilization early in the air treatment process advantageously ensures that particulate matter caught by the filters or otherwise remaining within the device is either killed or inactivated. Further, providing activated carbon/HEPA filtration after UV-C treatment enables enhanced odor control over reliance only on UV-C treatment to deactivate odors. Emission of a scent near the end of the process, for example using scent emitters or scent vents, advantageously enables any remaining odors to be hidden.

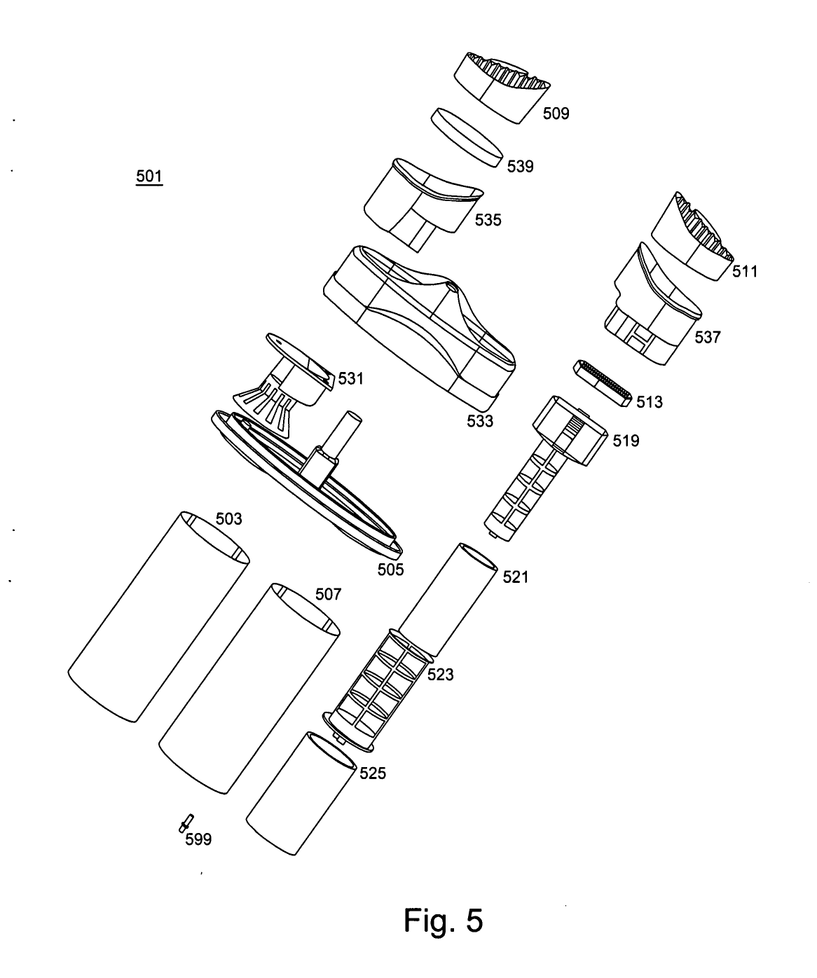

FIG. 5 illustrates, in greater detail, a first portion of another alternative exemplary embodiment of a portable device. In this first portion, reflective metallic tubes form the intake chamber 503 and the exhaust chamber 507. A light baffle 531 is disposed between the header upper 505 and the stamping upper 533. Above the intake chamber 503, a prefilter 539 is provided between an intake insert 535 and an airflow grid 509. On the exhaust chamber 507 side, a supplemental filter assembly includes a filter cage 519, a foam sleeve 521, a second sleeve 525 and a filter cap 523. The filter cage 519 includes a recess for receiving a scent vent 513. The filter cage also includes tabs for securing the supplemental filter assembly to the exhaust insert 537, which also receives an airflow grid 511. The exhaust insert 537 allows the supplemental filter assembly to hang securely within the exhaust chamber 507. A safety switch post 599 is also provided within the wall of either the intake or exhaust chambers 503, 507.

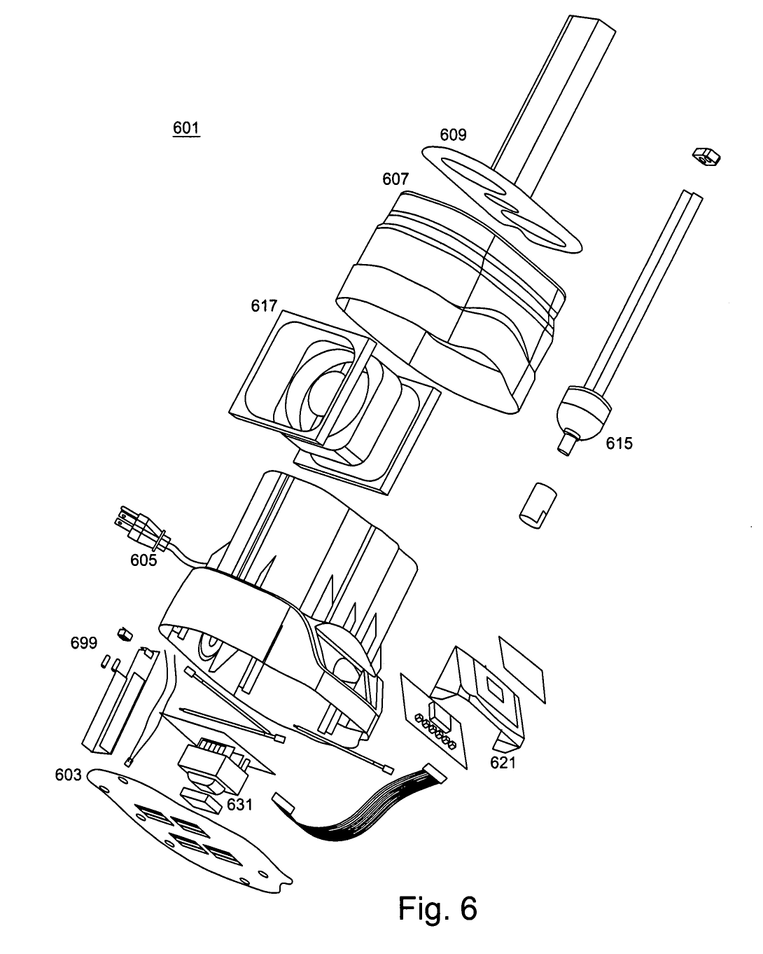

FIG. 6 illustrates, in greater detail, a second portion of another alternative exemplary embodiment of a portable device. A header lower 609 and stamping lower 607 support the intake 503 and exhaust 507 chambers. The base 605 includes a control unit 621 and power unit 631 and base plate 603. The base further supports the UV-C emitter 615 which includes a lamp pad and a UV-C bulb holder. The fan 617 is provided within the base between fan vibration and noise dampeners. The safety switch 699 in this configuration receives the safety switch post 599 provided in one of the intake or exhaust chambers 503, 507. Separation of the intake or exhaust chambers 503, 507 from the base 605 causes the switch 699 to detect an exposure condition.

Various embodiments of the device operate quietly, with acceptable noise including the sound of the air rushing through the unit. Feedback noise, humming, rattling from PWM or other components, especially at lower speeds, is reduced by providing dampening features such as vibration-dampening interfaces (for example, rubber or plastic) or structurally isolating vibrating components such as the fan. Selected embodiments of the device provide at least 22 cubic feet-per-minute (CFM) airflow at high speed with no filter.

In one pass, tests have shown that at least 98% of sebaccia marcescens (a surrogate for influenza which dies at the same rate as influenza A when exposed to UV-C light) is killed. The tests measured concentration of contaminants entering the unit and the concentration exiting of the unit. Embodiments of the system achieve UV-C energy intensities of 50 j/m², a sufficient dose to kill over 99% of flu, cold, TB, strep, and staph germs while processing one cubic foot of air. Certain embodiments of the device achieve 30 CFM (for example, using a 25 watt UV-C bulb). Embodiments of the system process 3 to 4 times more air than conventional models and still kill 98% of S. marcescens. In embodiments using a 23 W bulb, 21/22 CFM is achieved (equivalent to about 1260 CFH). As a normal 1200 square foot house with 9 foot ceilings includes 10800 CF, the air in this size house would be processed every 8.6 hours, or about three times per day when taking into account a sealed volume, even mixing, etc.

Additional tests have shown that embodiments of the device achieve over approximately 98% kill rate of staph in an aerosolized chamber at 20-21° C. and a relative humidity of 65-67%. Other tests demonstrated that embodiments of the device achieve over approximately 80-87% kill rate of natural germs in a room at 19-20° C. and a relative humidity of 30-40%.

The UV-C emitter is optionally used as a mold controller by broadcasting UV-C in a room. In this alternative embodiment, the emitter may be exposed by, for example, removing the intake enclosure or intake manifold. User safety may be enhanced by providing for a delayed and finite period of UV-C emitter operation using the control unit.

It is noted that the UV-C treatment and subsequent filtering of various disclosed embodiments may “vaccinate” users by exposing them to lower or less potent concentrations of bird flu, thereby reducing the impact of a subsequent outbreak. Flu vaccines are generally dead (inactive) virus injected into people to challenge immune systems. The new FluMist™ vaccine is a live but attenuated virus vaccine inhaled (not injected) by a person to challenge the immune system. Operating on similar principles, users of various disclosed embodiments including UV-C treatment may be being vaccinated by inactive virus after the virus is exposed to UV-C energy. These users may then build up immunity via the dead virus cells. Further, the same users are exposed to a diluted amount of live virus (since UV-C treatment reduces the concentration) and therefore may build up immunity to the virus. Accordingly, the UV-C provided by various disclosed embodiments may help both to prevent infection and to build up immunity in the case of exposure to dead and live virus cells.

Various embodiments advantageously destroy over 95% of common aerosolized household germs like cold and flu viruses in the air processed through the device. The processed, sanitized air has been shown to reduce influenza concentration by 98% or more. Further, various embodiments provide a constant and controlled airflow. Further, the various embodiments are portable and can be located closer to the source of germs or infectious particles. Additionally, by utilizing highly reflective material such as polished aluminum, various embodiments are able to reflect over 80% of the UV-C energy emitted inside the sterilization chamber, thereby significantly increasing the germ killing or neutralizing capability of UV-C energy.

Representative of good hygiene, the device can be used in a variety of environments including but not limited to, whole house/large rooms, offices, waiting rooms, etc.

1. A portable device for reducing airborne contaminants comprising:
an intake enclosure having an intake manifold at an open end thereof;
a UV light emitter disposed within said intake enclosure;
an exhaust enclosure having an exhaust manifold at an open end thereof;
an electrostatic filter disposed within said exhaust enclosure;
a second filter disposed within said exhaust enclosure, the second filter including at least one of activated carbon and HEPA filter material;
a base forming a base conduit connecting said intake enclosure and said exhaust enclosure and providing fluidic communication therebetween; and
a fan disposed in the base conduit, said fan being adapted to generate an airflow passing the UV light emitter in said intake enclosure and through the electrostatic and second filters in said exhaust enclosure.

2. The device of claim 1, wherein said electrostatic filter includes a first rigid support member having an apertured cylindrical wall and an electrostatic filter material overlying said cylindrical wall.

3. The device of claim 1, wherein said second filter removeably overlies said electrostatic filter.

4. The device of claim 3, wherein said second filter includes a second rigid support member having an apertured cylindrical wall overlying said electrostatic filter material, and a second filter material overlying said cylindrical wall of said second filter.

5. The device of claim 1, wherein said electrostatic filter is removeably disposed within said exhaust chamber.

6. The device of claim 5, wherein said second filter is removeably disposed within said exhaust chamber.

7. The device of claim 6, further comprising a scent emitter disposed within said exhaust manifold, the scent emitter including cellulose acetate.

8. The device of claim 1, wherein said UV light emitter emits light in the UV-C band.

9. The device of claim 1, wherein said UV light emitter emits light having wavelengths greater than 185 nm.

10. The device of claim 1, wherein said UV light emitter includes a quartz light emitting chamber and a base containing a ballast, the base including a threaded portion for connection to a socket.

11. The device of claim 1 further comprising a control unit including at least one of a fan controller, a timer, a programmer, and a clock.

12. The device of claim 11, wherein said control unit includes a fan controller configured to drive the fan at a plurality of fan speeds.

13. The device of claim 11, wherein said control unit includes a timer which records the time of operation of at least one component selected from the group consisting of the UV light emitter, the electrostatic filter, and the second filter.

14. The device of claim 13, wherein said timer resetably prompts for at least one of electrostatic filter replacement, second filter replacement, and UV emitter replacement.

15. The device of claim 11, wherein said control unit includes a programmer for automatically operating said device at a predetermined interval and at a predetermined fan speed.

16. The device of claim 1, further comprising a safety switch configured to detect an exposure condition of the UV light emitter and to disable the UV light emitter.

17. The device of claim 16, wherein the safety switch is disposed within the base and configured to detect a separation of the base from the intake enclosure.

18. The device of claim 1, further comprising a prefilter disposed upstream of the UV emitter, wherein an interior of the intake enclosure includes a material highly reflective to UV energy.

19. The device of claim 18, wherein the material is polished aluminum.

20. A portable device for reducing airborne contaminants comprising:
a base defining a cavity and having a size and weight suitable for being supported from a desk or table top;
a hollow sterilization column supported by said base at one end and extending upward to an open end, the interior of said sterilization column being in fluid communication with said cavity;
a sterilization manifold covering the open end of said sterilization column and providing fluid communication between the interior and exterior of said sterilization column;
a UV-C light emitter disposed within said sterilization column;
a hollow filtration column supported by said base at one end and extending upward to an open end, the interior of said filtration column being in fluid communication with said cavity;
a filtration manifold covering the open end of said filtration column and providing fluid communication between the interior and exterior of said filtration column;
an electrostatic filter disposed within said filtration column;
a second filter disposed within said filtration column, the second filter including at least one of activated carbon and HEPA filter material; and
a fan adapted to cause an airflow and disposed within said cavity in the airflow intermediate the UV light emitter and the electrostatic and second filters.

21. The device of claim 20, wherein said electrostatic and said second filter are removeably disposed within said exhaust chamber.

22. The device of claim 20, further comprising a threaded socket positioned within said base, wherein said UV emitter comprises an elongated quartz light emitting chamber extending along a longitudinal axis of said intake column and a threaded base connector received within said socket.

23. The device of claim 20, wherein said electrostatic filter includes a rigid support member having an apertured cylindrical wall and an electrostatic filter material overlying said cylindrical wall.

24. The device of claim 23, wherein said second filter removeably overlies said electrostatic filter.

25. The device of claim 24, wherein said second filter includes a rigid support member having an apertured cylindrical wall overlying said electrostatic filter material, and a second filter material overlying said cylindrical wall of said second filter.

26. The device of claim 25, further comprising a scent emitter disposed within said filtration manifold.

27. The device of claim 20, wherein the interior wall of said intake column is reflective to UV energy.

28. A method of reducing airborne contaminants comprising the steps of:
generating an airflow of contaminated air;
exposing the airflow to UV-C energy;
filtering the airflow with one of a carbon filter or a HEPA filter; and
filtering the airflow with an electrostatic filter.

29. The method of 28, further comprising exhausting the air from the filtration chamber into the space.

30. The method of claim 28, wherein generating an airflow includes drawing air from the space into a sterilization chamber and causing the air to flow through the sterilization chamber.

31. The method of 30, further comprising moving the air flowing from the sterilization chamber into a filtration chamber and causing the air to flow through the filtration chamber, wherein the steps of filtering are performed in the filtration chamber.
